(19) United States
(12) Patent Application Publication
(10) Pub. No.: US 2026/0162870 A1
(43) Pub. Date: Jun. 11, 2026

(54) COIL COMPONENT AND METHOD FOR MANUFACTURING THE SAME

(71) Applicant: Murata Manufacturing Co., Ltd., Kyoto-fu (JP)

(72) Inventors: Mutsumi YOKOHAMA, Nagaokakyo-shi (JP); Masayoshi NAKAMURA, Nagaokakyo-shi (JP); Keita ASAI, Nagaokakyo-shi (JP)

(73) Assignee: Murata Manufacturing Co., Ltd., Kyoto-fu (JP)

(21) Appl. No.: 19/178,136

(22) Filed: Apr. 14, 2025

(30) Foreign Application Priority Data
Apr. 25, 2024 (JP) 2024-071573

(51) Int. Cl. H01F 27/24; H01F 27/28; H01F 27/32; H01F 41/02; H01F 41/066; H01F 41/12

(52) U.S. Cl. CPC H01F 27/24; H01F 27/2823; H01F 27/324; H01F 41/0206; H01F 41/066; H01F 41/12

(57) ABSTRACT

A coil component includes a drum-shaped core including a winding core portion, and a first flange portion and a second flange portion respectively provided at a first end portion and a second end portion located opposite to each other in an axial direction of the winding core portion; a plate-shaped core having a first main surface and a second main surface that face in opposite directions, the first main surface facing the winding core portion, the plate-shaped core being disposed in a state of extending between the first flange portion and the second flange portion; and wires wound around the winding core portion in a state of each forming a plurality of turns. A fixing material containing a resin fixes at least part of each of the wires to the first main surface of the plate-shaped core.

### CROSS-REFERENCE TO RELATED APPLICATION

This application claims benefit of priority to Japanese Patent Application No. 2024-071573, filed Apr. 25, 2024, the entire content of which is incorporated herein by reference.

### BACKGROUND

### Technical Field

The present disclosure relates to a coil component and a method for manufacturing the coil component. The coil component includes a drum-shaped core and a plate-shaped core. The drum-shaped core includes a winding core portion around which a wire is wound, and a first flange portion and a second flange portion provided at respective end portions of the winding core portion. The plate-shaped core is disposed in a state of extending between the first flange portion and the second flange portion. In particular, the present disclosure relates to an improvement for stabilizing the state in which the wire is wound around the winding core portion.

### Background Art

For example, Japanese Unexamined Patent Application Publication No. 2022-34593 describes a coil component including a drum-shaped core including a winding core portion, and a first flange portion and a second flange portion provided at respective end portions of the winding core portion, a wire being wound around the winding core portion of the drum-shaped core.

### SUMMARY

A coil component is subjected to an external force during transportation or mounting of the coil component, for example. Such an external force sometimes causes misalignment of a wire wound around a winding core portion of a coil component having a structure as described in Japanese Unexamined Patent Application Publication No. 2022-34593. The misalignment of the wire undesirably changes the electrical characteristics of the coil component and is thus not preferable.

Accordingly, the present disclosure stabilizes the state in which a wire is wound around a winding core portion of a coil component.

First, the present disclosure relates to a coil component including a drum-shaped core including a winding core portion, and a first flange portion and a second flange portion respectively provided at a first end portion and a second end portion located opposite to each other in an axial direction of the winding core portion; and a wire wound around the winding core portion in a state of forming a plurality of turns.

The coil component according to the present disclosure further includes a plate-shaped core having a first main surface and a second main surface that face in opposite directions, the first main surface facing the winding core portion, the plate-shaped core being disposed in a state of extending between the first flange portion and the second flange portion. In addition, a fixing material containing a resin fixes at least part of the wire to the first main surface of the plate-shaped core.

In addition, the present disclosure relates to a method for manufacturing a coil component including a drum-shaped core including a winding core portion, and a first flange portion and a second flange portion respectively provided at a first end portion and a second end portion located opposite to each other in an axial direction of the winding core portion, a plate-shaped core having a first main surface and a second main surface that face in opposite directions, the first main surface facing the winding core portion, the plate-shaped core being disposed in a state of extending between the first flange portion and the second flange portion, and a wire wound around the winding core portion in a state of forming a plurality of turns.

The method for manufacturing a coil component according to the present disclosure includes a winding step of winding the wire around the winding core portion; a resin applying step of applying a resin to the wire; and a fixing step of fixing at least part of the wire to the first main surface of the plate-shaped core via the resin.

According to the present disclosure, the wire wound around the winding core portion is fixed to the plate-shaped core to stabilize the state in which the wire is wound around the winding core portion. Accordingly, even when the coil component is subjected to an external force during transportation or mounting of the coil component, misalignment of the wire is less likely to occur, thus enabling the electrical characteristics of the coil component to be less likely to undesirably change.

### BRIEF DESCRIPTION OF THE DRAWINGS

FIG. 1 is a front view illustrating the exterior of a coil component 1 according to Embodiment 1 of the present disclosure;

FIG. 2 is a bottom view of the coil component 1 illustrated in FIG. 1;

FIG. 3 is a sectional view of a coil component 1a according to Embodiment 2 of the present disclosure;

FIG. 4 is a sectional view of a coil component 1b according to Embodiment 3 of the present disclosure;

FIG. 5 is a sectional view of a coil component 1c according to Embodiment 4 of the present disclosure; and

FIG. 6 is a sectional view of a wire 26 used in Embodiment 5 of the present disclosure.

### DETAILED DESCRIPTION

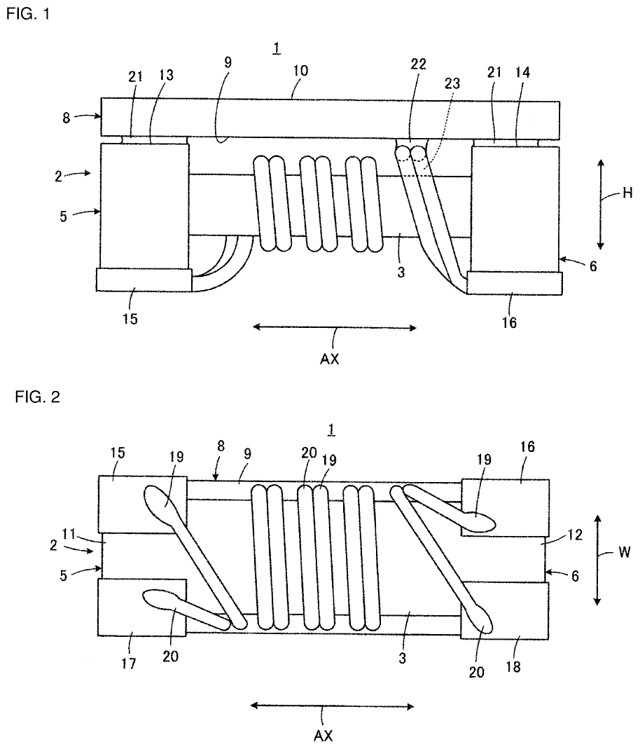

A coil component 1 according to Embodiment 1 of the present disclosure will be described with reference to FIGS. 1 and 2. For example, the coil component 1 forms a common mode choke coil.

As illustrated in FIG. 1, the coil component 1 includes a drum-shaped core 2 made of a magnetic material such as a magnetic substance such as ferrite or a resin containing ferrite powder or metal magnetic powder. The drum-shaped core 2 includes a winding core portion 3, and a first flange portion 5 and a second flange portion 6 respectively provided at a first end portion and a second end portion located opposite to each other in an axial direction AX of the winding core portion 3.

The coil component 1 further includes a plate-shaped core 8 disposed in a state of extending between the first flange portion 5 and the second flange portion 6. The plate-shaped core 8 has a first main surface 9 and a second main surface 10 facing in opposite directions. In FIG. 1, the first main surface 9 faces downward, and the second main surface 10 faces upward. Similarly to the case of the drum-shaped core 2, the plate-shaped core 8 is preferably made of a magnetic material such as a magnetic substance such as ferrite or a resin containing ferrite powder or metal magnetic powder. Thus, in cooperation with the drum-shaped core 2, the plate-shaped core 8 forms a closed magnetic circuit.

The first flange portion 5 and the second flange portion 6 respectively have bottom surfaces 11 and 12, which face a mounting substrate (not illustrated) side when being mounted, and top surfaces 13 and 14, which are located opposite to the bottom surfaces 11 and 12. The first main surface 9 of the plate-shaped core 8 and the top surfaces 13 and 14 of the first flange portion 5 and the second flange portion 6 face each other.

As specifically illustrated in FIG. 2, a first terminal electrode 15 and a third terminal electrode 17 are provided side by side in a width direction W on the bottom surface 11 side of the first flange portion 5, and a second terminal electrode 16 and a fourth terminal electrode 18 are provided side by side in the width direction W on the bottom surface 12 side of the second flange portion 6. For example, the terminal electrodes 15 to 18 are formed by dipping or applying a conductive paste containing conductive metal powder such as Ag powder, then baking the conductive paste, and then subjecting the baked conductive paste to Ni plating and Sn plating. Alternatively, for example, the terminal electrodes 15 to 18 may be formed by attaching, to flange portions 5 and 6, conductive metal pieces made of a copper-based metal such as tough pitch copper or phosphor bronze.

For example, two wires 19 and 20 are spirally wound parallel to each other around the winding core portion 3 in a state of each forming a plurality of turns. For example, the wires 19 and 20 are copper wires insulated and covered with a resin such as a polyamide-imide resin, a polyurethane resin, or a polyester-imide resin. One end of the first wire 19 is connected to the first terminal electrode 15, and the other end of the first wire 19 is connected to the second terminal electrode 16. One end of the second wire 20 is connected to the third terminal electrode 17, and the other end of the second wire 20 is connected to the fourth terminal electrode 18. The terminal electrodes 15 to 18 are connected to the wire 19 or the wire 20 by thermocompression bonding, ultrasonic welding, or laser welding, for example.

The plate-shaped core 8 is formed separately from the drum-shaped core 2. As illustrated in FIG. 1, the plate-shaped core 8 is joined to the first flange portion 5 and the second flange portion 6 via an adhesive 21. The adhesive 21 is applied between the first main surface 9 of the plate-shaped core 8 and the top surfaces 13 and 14 of the flange portions 5 and 6. The adhesive 21 contains a resin. For example, a thermosetting resin or an ultraviolet curable resin is used as such a resin. The adhesive 21 preferably contains metal magnetic powder to improve the magnetic characteristics of the coil component 1. For example, Ni powder or Fe powder is used as such metal magnetic powder.

The plate-shaped core 8 may be prepared in a state of being formed integrally with the drum-shaped core 2. In this case, a gap defining a space through which the wires 19 and 20 to be wound around the winding core portion 3 pass in a winding step of the wires 19 and 20 is preferably provided to part of the plate-shaped core 8, part of the first flange portion 5, or part of the second flange portion 6.

In a characteristic configuration of the present embodiment, at least part of each of the wires 19 and 20 is fixed to the first main surface 9 of the plate-shaped core 8. A fixing material 22 serving for the fixation is illustrated in FIG. 1. The fixing material 22 contains a resin. For example, a thermosetting resin, a thermoplastic resin, or an ultraviolet curable resin is used as such a resin. The adhesive 21 for joining the plate-shaped core 8 described above to the flange portions 5 and 6 preferably contains a resin having the same components as those of a resin contained in the fixing material 22. This is because it is possible to simplify the process management and to simultaneously perform a step of applying the adhesive 21 and a step of applying the fixing material 22, thus making the manufacture efficient. The resin contained in the fixing material 22 may contain the same metal magnetic powder as that used in the adhesive 21. The fixing material 22 and the adhesive 21 may have the same composition.

As illustrated in FIG. 1, the fixing material 22 is preferably applied so as to fix, to the first main surface 9 of the plate-shaped core 8, one of the first winding turn and the last winding turn of each of the wires 19 and 20 spirally extending and wound around the winding core portion 3. The first winding turn and the last winding turn of each of the wires 19 and 20 are closest to the terminal electrodes 15 to 18 and are thus likely to be affected by an external force in a mounting step of the coil component 1. Accordingly, fixation of one of the first winding turn and the last winding turn of each of the wires 19 and 20 is effective for making misalignment of the wires 19 and 20 less likely to occur.

The terms “first winding turn” and “last winding turn” are used in the above description. However, it is possible to freely determine which side the winding starts from or ends on, and it can be said that any determined configuration is essentially the same.

Although not illustrated, the fixing material 22 is a part facing the plate-shaped core 8 side of the spirally extending wires 19 and 20 and may be applied to the entire region in the axial direction AX.

For example, when a turn of each of the wires 19 and 20 that is one of the first winding turn and the last winding turn of each of the wires 19 and 20 is fixed to the first main surface 9 of the plate-shaped core 8 by the fixing material 22, as illustrated in FIG. 1, the turn fixed by the fixing material 22, that is, one of the first winding turn and the last winding turn, forms a larger space 23 between the turn and the winding core portion 3 than the other turns of the wires 19 and 20 and is located on the further outside of the outer peripheral side of the winding core portion 3 than the other turns.

The space 23 between the winding core portion 3 and the wires 19 and 20 described above is effective for reducing the stray capacitance generated between the drum-shaped core 2 and the wires 19 and 20.

In addition, in the present embodiment, as is clear from FIG. 1, the position of the outer peripheral side of the turn of each of the wires 19 and 20 fixed by the fixing material 22, that is, the position of the outer peripheral side of the first winding turn or the last winding turn, is located at the same level in a height direction H as the position of each of the top surfaces 13 and 14 facing the plate-shaped core 8 side of the first flange portion 5 and the second flange portion 6.

As described above, the present embodiment has a characteristic in which the turn fixed by the fixing material 22 is located on the further outside of the outer peripheral side of the winding core portion 3 than the other turns, and a characteristic in which the position of the outer peripheral side of the turn fixed by the fixing material 22 is located at the same level as the position of each of the top surfaces 13 and 14 facing the plate-shaped core 8 side of the first flange portion 5 and the second flange portion 6. The provision of these characteristics enables a resin to be common to the adhesive 21 and the fixing material 22 and enables the adhesive 21 and the fixing material 22 to be simultaneously applied when part of each of the wires 19 and 20 and part of each of the first flange portion 5 and the second flange portion 6 are dipped into a liquid resin once.

In addition, in the present embodiment, the fixing material 22 performs the function of fixing the first wire 19 and the second wire 20 wound around the winding core portion 3 to each other. In particular, the turn of the first wire 19 is fixed, by the fixing material 22, to the turn of the second wire 20 whose place is the same as that of the turn of the first wire 19. Accordingly, the state in which the position of the first wire 19 is relatively the same as the position of the second wire 20 is maintained, thus enabling the common mode choke coil to have excellent characteristics.

The fixing material 22 functions as both a first fixing material that fixes the first wire 19 to the first main surface 9 of the plate-shaped core 8 and a second fixing material that fixes the second wire 20 to the first main surface 9 of the plate-shaped core 8.

The first fixing material that fixes the first wire 19 to the first main surface 9 of the plate-shaped core 8 and the second fixing material that fixes the second wire 20 to the first main surface 9 of the plate-shaped core 8 may be individually provided as fixing materials. In this case, the first fixing material and the second fixing material may be located at different places. For example, the first fixing material and the second fixing material may be disposed such that the first fixing material fixes the first winding turn of the first wire and the second fixing material fixes the last winding turn of the second wire.

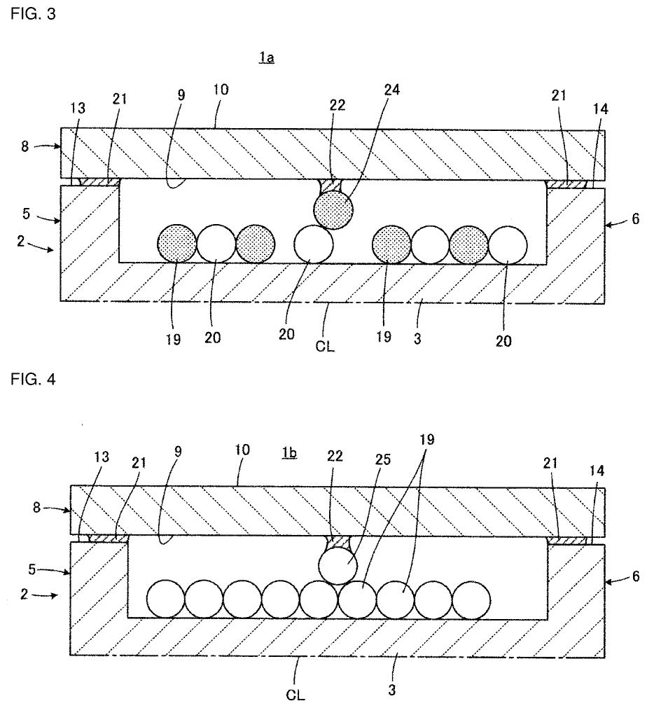

FIG. 3 is a sectional view of a coil component 1a according to Embodiment 2 of the present disclosure. In FIG. 3, the components corresponding to components illustrated in FIG. 1 have the same reference signs, and duplicate descriptions are omitted. In FIG. 3, the part below a central axis CL of the winding core portion 3 is not illustrated. In addition, in FIG. 3, the first wire 19 is shaded to distinguish the first wire 19 and the second wire 20.

When referring to FIG. 3, the first wire 19 and the second wire 20 are spirally wound parallel to each other around the winding core portion 3 in a state of each forming a plurality of turns, and the first wire 19 forms an intersection portion 24, which is provided on part of the second wire 20 and intersects with the second wire 20. The state in which the first wire 19 is wound is likely to be unstable at the intersection portion 24. Accordingly, the fixing material 22 is applied so as to fix, to the first main surface 9 of the plate-shaped core 8, the turn of the first wire 19 where the intersection portion 24 is provided.

In a modification example of the embodiment illustrated in FIG. 3, in a region where the first wire 19 and the second wire 20 are spirally wound parallel to each other around the winding core portion 3 in a state of each forming a plurality of turns, for example, the first wire 19 and the second wire 20 may be wound to form a plurality of layers such that the first wire 19 is located on the lower layer side and the second wire 20 is located on the upper layer side.

FIG. 4 is a sectional view of a coil component 1b according to Embodiment 3 of the present disclosure. In FIG. 4, the components corresponding to components illustrated in FIG. 1 have the same reference signs, and duplicate descriptions are omitted. Also in FIG. 4, the part below the central axis CL of the winding core portion 3 is not illustrated.

In the embodiment illustrated in FIG. 4, only one wire 19 is wound around the winding core portion 3. The wire 19 has predetermined lower layer side turns around the winding core portion 3, and an upper layer side turn 25 provided on some of the lower layer side turns. The state in which the wire 19 is wound is likely to be unstable at the upper layer side turn 25. Accordingly, the fixing material 22 is applied so as to fix the upper layer side turn 25 to the first main surface 9 of the plate-shaped core 8.

In the embodiment illustrated in FIG. 4, the number of the upper layer side turns 25 to be wound is not limited to one and may be two or more. In this case, the fixing material 22 may be applied so as to fix some or all of the upper layer side turns 25 to the first main surface 9 of the plate-shaped core 8.

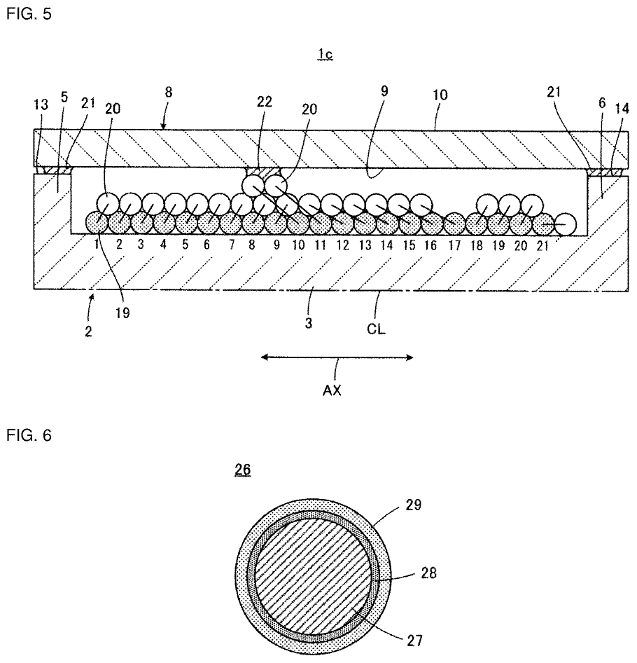

FIG. 5 is a sectional view of a coil component 1c according to Embodiment 4 of the present disclosure. In FIG. 5, the components corresponding to components illustrated in FIG. 1 have the same reference signs, and duplicate descriptions are omitted. Also in FIG. 5, the part below the central axis CL of the winding core portion 3 is not illustrated.

In addition, in FIG. 5, the section representing the first wire 19 is shaded to clearly distinguish the first wire 19 and the second wire 20. The first wire 19 is spirally wound so as to run in the axial direction AX in a state of forming a first layer in contact with a peripheral surface of the winding core portion 3. The second wire 20 has turns whose number is substantially the same as that of the turns of the first wire 19 and is spirally wound so as to run in the axial direction AX in the state in which most of the turns of the second wire 20 form a second layer located on the outer peripheral side of the first layer.

In FIG. 5, the turns of the first wire 19 are connected to the respective turns of the second wire 20 by line segments. In this manner, turns connected by a line segment are turns whose places are the same from a left end portion of the winding core portion 3 in the figure. Numbers are assigned to respective parts below the turns of the first wire 19. These numbers represent respective places of the turns of the first wire 19. Accordingly, the turns of the second wire 20 connected to the respective turns of the first wire 19 by the line segments also occupy places that are the same as the respective places represented by the numbers described above. In the winding state illustrated in FIG. 5, the first wire 19 and the second wire 20 each have first to twenty-first turns.

As illustrated in FIG. 5, in a region where the first wire 19 and the second wire 20 are spirally wound around the winding core portion 3 in a state of each forming a plurality of turns, for example, the first wire 19 and the second wire 20 may be wound to form three layers such that the first wire 19 forms the first layer and the second wire 20 forms the second layer and a third layer. In this case, the state in which the second wire 20 is wound is likely to be unstable at a tenth turn and an eleventh turn of the third layer located on the upper layer side. Accordingly, the fixing material 22 is applied so as to fix, to the first main surface 9 of the plate-shaped core 8, the tenth turn and the eleventh turn of the second wire 20 forming the third layer located on the upper layer side.

In a modification example of the embodiment illustrated in FIG. 5, the first wire 19 and the second wire 20 may be wound around the winding core portion 3 to form four or more layers. In addition, each layer may be formed by any or both of the turns of the first wire 19 and the turns of the second wire 20.

For example, a winding step of winding the wires 19 and 20 (or the wire 19) around the winding core portion 3, a resin applying step of applying a resin to the wires 19 and 20 (or the wire 19), and a fixing step of fixing at least part of each of the wires 19 and 20 (or the wire 19) to the first main surface 9 of the plate-shaped core 8 via the resin are performed to manufacture the coil components 1, 1a, 1b, and 1c described above. When the plate-shaped core 8 is formed separately from the drum-shaped core 2, a step of fixing the plate-shaped core 8 to the first flange portion 5 and the second flange portion 6 via the resin is performed in the fixing step.

In particular, when manufacturing the coil components 1, 1a, 1b, and 1c, the resin to be applied in the resin applying step forms the fixing material 22, and the resin applying step includes a step of applying the resin forming the fixing material 22 to the wires 19 and 20 (or the wire 19) wound around the winding core portion 3.

When the resin to be applied in the resin applying step is an ultraviolet curable resin, the resin is irradiated with ultraviolet rays in the fixing step.

On the other hand, the resin applying step may include a step of applying a resin to the wires 19 and 20 (or the wire 19) yet to be wound around the winding core portion 3. In Embodiment 5, a wire 26 illustrated in FIG. 6 is used.

FIG. 6 is a sectional view of the wire 26 used in Embodiment 5 of the present disclosure. The wire 26 includes a core wire 27, which is made of a highly conductive metal such as copper, and a cover layer 28, which covers a peripheral surface of the core wire 27 and is made of an electrically insulating resin. The wire 26 further includes a fusion layer 29 covering a cover layer 28. For example, the fusion layer 29 is made of a thermoplastic resin.

When the wire 26 illustrated in FIG. 6 is used, the resin applying step is already performed before the winding step described above, and the fixing step of fixing at least part of the wire to the first main surface of the plate-shaped core via a resin includes a step of heating the fusion layer 29.

When the fusion layer 29 described above has a highly reliable electrically insulating property, the cover layer 28 may be omitted, and the fusion layer 29 may be formed on the core wire 27.

The present disclosure has been described above with reference to the illustrated embodiments, but other various modification examples can be implemented within the scope of the present disclosure.

For example, coil components according to the present disclosure may form a transformer, a balun, or other devices other than a common mode choke coil as in the illustrated embodiments, or a single coil. Thus, the number of wires is also changed according to the functions of the coil components. Accordingly, the number of terminal electrodes provided on each flange portion may also be changed.

In addition, the shapes of the drum-shaped core and the plate-shaped core included in each coil component are not limited to the illustrated shapes and can be freely changed according to desired designs.

In addition, when forming the coil component according to the present disclosure or performing a method for manufacturing the coil component according to the present disclosure, configurations or steps of different embodiments described in the specification can be partially replaced or combined.

The present disclosure includes the following embodiments.
<1> A coil component comprising a drum-shaped core including a winding core portion, and a first flange portion and a second flange portion respectively provided at a first end portion and a second end portion located opposite to each other in an axial direction of the winding core portion; a plate-shaped core having a first main surface and a second main surface that face in opposite directions, the first main surface facing the winding core portion, the plate-shaped core being disposed in a state of extending between the first flange portion and the second flange portion; a first wire wound around the winding core portion in a state of forming a plurality of turns; and a first fixing material containing a resin and fixing at least part of the first wire to the first main surface of the plate-shaped core.
<2> The coil component according to <1>, wherein the first fixing material fixes one of a first winding turn and a last winding turn of the first wire to the first main surface of the plate-shaped core.
<3> The coil component according to <1> or <2>, wherein the plate-shaped core is formed separately from the drum-shaped core and is joined to the first flange portion and the second flange portion via an adhesive.
<4> The coil component according to <3>, wherein the adhesive contains a resin having the same components as components of the resin contained in the first fixing material.
<5> The coil component according to <3> or <4>, wherein the first fixing material and the adhesive contain metal magnetic powder.
<6> The coil component according to any one of <3> to <5>, wherein a turn of the first wire is fixed to the first main surface of the plate-shaped core by the first fixing material, and the turn fixed by the first fixing material forms a larger space between the turn and the winding core portion than other turns of the first wire and is located on a further outside of an outer peripheral side of the winding core portion than the other turns.
<7> The coil component according to <6>, wherein a position of an outer peripheral side of the turn fixed by the first fixing material is located at the same level as a position of each of surfaces facing the plate-shaped core of the first flange portion and the second flange portion.
<8> The coil component according to any one of <1> to <5>, wherein the first wire has predetermined lower layer side turns around the winding core portion, and an upper layer side turn provided on some of the lower layer side turns, and the first fixing material fixes the upper layer side turn to the first main surface of the plate-shaped core.
<9> The coil component according to any one of <1> to <5>, further comprising a second wire wound around the winding core portion. The first wire forms an intersection portion provided on part of the second wire and intersecting with the second wire, and the first fixing material fixes, to the first main surface of the plate-shaped core, a turn of the first wire where the intersection portion is provided.
<10> The coil component according to any one of <1> to <5>, further comprising a second wire wound around the winding core portion. The first wire and/or the second wire is wound around the winding core portion to form a first layer to an n-th layer, where n is an integer equal to or more than 3, and the first fixing material fixes a turn of the n-th layer of the first wire and/or the second wire to the first main surface of the plate-shaped core.
<11> The coil component according to <10>, wherein n is 3.
<12> The coil component according to any one of <1> to <11>, further comprising a second wire wound around the winding core portion, wherein the first fixing material fixes the first wire and the second wire to each other.
<13> The coil component according to any one of <1> to <12>, further comprising a second wire wound around the winding core portion; and a second fixing material that fixes at least part of the second wire to the first main surface of the plate-shaped core.
<14> A method for manufacturing a coil component including a drum-shaped core including a winding core portion, and a first flange portion and a second flange portion respectively provided at a first end portion and a second end portion located opposite to each other in an axial direction of the winding core portion, a plate-shaped core having a first main surface and a second main surface that face in opposite directions, the first main surface facing the winding core portion, the plate-shaped core being disposed in a state of extending between the first flange portion and the second flange portion, and a wire wound around the winding core portion in a state of forming a plurality of turns. The method comprises a winding step of winding the wire around the winding core portion; a resin applying step of applying a resin to the wire; and a fixing step of fixing at least part of the wire to the first main surface of the plate-shaped core via the resin.
<15> The method for manufacturing a coil component according to <14>, wherein the resin applying step includes a step of applying a resin to the wire wound around the winding core portion.
<16> The method for manufacturing a coil component according to <15>, further comprising a step of preparing the drum-shaped core; and a step of preparing the plate-shaped core formed separately from the drum-shaped core. The resin applying step includes a step of simultaneously dipping, into a liquid resin, part of the wire wound around the winding core portion and part of each of the first flange portion and the second flange portion of the drum-shaped core. The fixing step includes a step of fixing at least part of the wire to the first main surface of the plate-shaped core and fixing the plate-shaped core to the first flange portion and the second flange portion via the resin.
<17> The method for manufacturing a coil component according to <16>, wherein a turn of the wire wound around the winding core portion in the winding step forms a larger space between the turn and the winding core portion than other turns of the wire and is located on a further outside of an outer peripheral side of the winding core portion than the other turns.
<18> The method for manufacturing a coil component according to <14>, wherein the resin applying step includes a step of applying a resin to the wire yet to be wound around the winding core portion.

What is claimed is:

1. A coil component comprising:
a drum-shaped core including
a winding core portion, and
a first flange portion and a second flange portion respectively at a first end portion and a second end portion that are opposite to each other in an axial direction of the winding core portion;
a plate-shaped core having a first main surface and a second main surface that face in opposite directions, the first main surface facing the winding core portion, the plate-shaped core extending between the first flange portion and the second flange portion;
a first wire wound around the winding core portion to configure a plurality of turns; and
a first fixing material including a resin and fixing at least part of the first wire to the first main surface of the plate-shaped core.

2. The coil component according to claim 1, wherein
the first fixing material fixes one of a first winding turn and a last winding turn of the first wire to the first main surface of the plate-shaped core.

3. The coil component according to claim 1, wherein
the plate-shaped core is separate from the drum-shaped core and is joined to the first flange portion and the second flange portion via an adhesive.

4. The coil component according to claim 3, wherein
the adhesive includes a resin having the same components as components of the resin included in the first fixing material.

5. The coil component according to claim 3, wherein
the first fixing material and the adhesive include metal magnetic powder.

6. The coil component according to claim 3, wherein
a turn of the first wire is fixed to the first main surface of the plate-shaped core by the first fixing material, and
the turn fixed by the first fixing material defines a larger space between the turn and the winding core portion than other turns of the first wire and is on a further outside of an outer peripheral side of the winding core portion than the other turns.

7. The coil component according to claim 6, wherein
a position of an outer peripheral side of the turn fixed by the first fixing material is at a same level as a position of each of surfaces facing the plate-shaped core of the first flange portion and the second flange portion.

8. The coil component according to claim 1, wherein
the first wire has predetermined lower layer side turns around the winding core portion, and an upper layer side turn on some of the lower layer side turns, and
the first fixing material fixes the upper layer side turn to the first main surface of the plate-shaped core.

9. The coil component according to claim 1, further comprising:
a second wire wound around the winding core portion, wherein
the first wire configures an intersection portion on part of the second wire and intersecting with the second wire, and
the first fixing material fixes, to the first main surface of the plate-shaped core, a turn of the first wire at the intersection portion.

10. The coil component according to claim 1, further comprising:
a second wire wound around the winding core portion, wherein
at least one of the first wire or the second wire is wound around the winding core portion to configure a first layer to an n-th layer, where n is an integer equal to or more than 3, and
the first fixing material fixes a turn of the n-th layer of the at least one of the first wire or the second wire to the first main surface of the plate-shaped core.

11. The coil component according to claim 10, wherein n is 3.

12. The coil component according to claim 1, further comprising:
a second wire wound around the winding core portion, wherein
the first fixing material fixes the first wire and the second wire to each other.

13. The coil component according to claim 1, further comprising:
a second wire wound around the winding core portion; and
a second fixing material that fixes at least part of the second wire to the first main surface of the plate-shaped core.

14. A method for manufacturing a coil component,
the coil component including
a drum-shaped core including
a winding core portion, and
a first flange portion and a second flange portion respectively at a first end portion and a second end portion that are opposite to each other in an axial direction of the winding core portion,
a plate-shaped core having a first main surface and a second main surface that face in opposite directions, the first main surface facing the winding core portion, and the plate-shaped core extending between the first flange portion and the second flange portion, and
a wire wound around the winding core portion to configure a plurality of turns,
the method comprising:
winding the wire around the winding core portion;
applying a resin to the wire; and
fixing at least part of the wire to the first main surface of the plate-shaped core via the resin.

15. The method for manufacturing a coil component according to claim 14, wherein
the applying includes applying a resin to the wire wound around the winding core portion.

16. The method for manufacturing a coil component according to claim 15, further comprising:
preparing the drum-shaped core; and
preparing the plate-shaped core separate from the drum-shaped core, wherein
the resin applying includes simultaneously dipping, into a liquid resin, part of the wire wound around the winding core portion and part of each of the first flange portion and the second flange portion of the drum-shaped core, and
the fixing includes fixing at least part of the wire to the first main surface of the plate-shaped core and fixing the plate-shaped core to the first flange portion and the second flange portion via the resin.

17. The method for manufacturing a coil component according to claim 16, wherein
a turn of the wire wound around the winding core portion in the winding defines a larger space between the turn and the winding core portion than other turns of the wire and is on a further outside of an outer peripheral side of the winding core portion than the other turns.

18. The method for manufacturing a coil component according to claim 14, wherein
the resin applying includes applying a resin to the wire yet to be wound around the winding core portion.
